(19) United States
(12) Patent Application Publication
(10) Pub. No.: US 2007/0094702 A1
(43) Pub. Date: Apr. 26, 2007

(54) Method and apparatus for remote personal video storage and retrieval

(75) Inventors: Rajendra Kumar Khare, Bangalore (IN); Brajabandhu Mishra, Orissa (IN); Sandeep Kumar Relan, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: BROADCOM CORPORATION

(21) Appl. No.: 11/256,174

(22) Filed: Oct. 24, 2005

(51) Int. Cl. H04N 7/16; H04N 7/173

(52) U.S. Cl. 725/134; 725/142; 725/89

(57) ABSTRACT

A personal video recorder network facilities the recording and storage of video data, such as home videos, on a remote storage provided by a service provider. The remote storage can be shared among users. Access control is provided for security. A PVR client is used to access the storage and display such stored video content. In one embodiment, the PVR storage is incorporated into a set-top-box.

### BACKGROUND OF THE INVENTION

1. Field of the Invention:

This invention is directed to the field of personal video recording (PVR) and distribution of video data such as live video broadcasts, movies, and other programs, which may be distributed by satellite, cable television or other transmission sources.

2. Description of the Related Art:

Cable television (TV) has become a widely subscribed to commodity. Cable TV typically comprises a plurality of audio/video (A/V) transmissions accumulated in a central office, for example. The A/V transmissions are often recorded by a VCR by user, to which a TV is plugged in. Other means of locally storing programmed content from a TV exist. However, there is a problem in sharing such content saved locally. They cannot be easily shared. For example, VCR tapes or DVDs created have to be shipped via postal services to remote locations for viewing by remote users. Storing and managing tapes is also a big problem when they increase in number.

Similarly, camcorders are used by people to record events that are important to them. Camcorders may be connected to a TV for viewing. Video from camcorders can also be taped, such as by means of a VCR. Also camcorders uses the tapes to records the video directly. Such tapes may be stored and managed locally by a user. However, managing all those tapes over time is a problem that takes time, space ad energy. Shipping tapes to remote users, so that remote users may take a look at them, is also expensive in terms of shipping costs but also requires the capability of copying tapes or DVDs before a copy can be shipped. Often a second DVD player or VCR is required to facilitate copying.

Typically, cable TV transmissions (channels) are distributed to end-users over cables, thus cable TV. When a user wants to share a TV show with his friend, the viewer has to tape the show and physically send the tape to his friend at some inconvenience and expense. Quite often, to tape a TV show or to tape a video shot with a camcorder, an existing tape or DVD media is erased and reused, often when an extra tape or DVD media is not available. Tapes and DVDs have to purchase and a stock of such media kept in order to be able to use them when needed, without having to erase others or reuse others that have already been recorded over.

In the last few years, systems such as the TiVo (tm) system, which stores data digitally on a hard drive system, has gained some momentum. However, the TiVo system does not provide remote storage means, rather, it provides local storage means at the user's premises. For example, the Phillips Stand-Alone TiVos have two IDE drive bays. Thus, extra storage space may be added by adding extra storage bays. Some models (the 14 hour, 20 hour, and some of the 30 hour ones) ship with only one drive—others ship with two. To be able to upgrade your TiVo's storage, you want one of these one-drive units. The present invention deals with remote storage to store video programs wherein a secure storage space is used by a user to store his favorite programs ad share them with others.

Further limitations and disadvantages of conventional and traditional approaches will become apparent to one of ordinary skill in the art through comparison of such systems with the present invention.

### SUMMARY OF THE INVENTION

Aspects of the present invention may be seen in a personal video recorders (PVR) network that facilitates the capture, storage, sharing and subsequent retrieval of video content, such as home video or broadcast programming, onto a remote storage facility.

Aspects of the present invention may be seen in a personal video recorder (PVR) system comprising a PVR client, a PVR server communicatively coupled to the PVR client system over a communications medium and a display unit coupled to the PVR client. The personal video recorder system enables shared access to video content stored at the PVR server such that the PVR client can retrieve the video content and display it on the display unit.

Aspects of the present invention may also be seen in a personal video recorder network comprising a first local video system that in turn comprises a local video display. The personal video recorder network also comprises a remote storage and a user access control.

Aspects of the present invention may also be found in a personal video recorder network that requires no local storage facility. The personal video recorder network comprises a PVR client system for capturing a local video data and a PVR server system communicatively coupled to the PVR client system for facilitating the storage and retrieval of the local video data. It also comprises a display unit communicatively coupled to the PVR client system for displaying the local video data.

In one embodiment, the personal video recorder network further comprises a set-top-box and/or TV communicatively coupled to the PVR client system that enables reception of cabled programming. The PVR server system is communicatively coupled to the set-top-box and employs the set-top-box to communicate with the PVR client system.

These and other features and advantages of the present invention may be appreciated from a review of the following detailed description of the present invention, along with the accompanying figures in which like reference numerals refer to like parts throughout.

### BRIEF DESCRIPTION OF THE DRAWINGS

FIG. 1 illustrates a block diagram of an exemplary personal video recorder network in accordance with an embodiment of the present invention;

FIG. 2 is a block diagram of a personal video recorder network that comprises a PVR client system communicatively coupled to a PVR server system via a set-top-box 221 and a cable TV transmission system;

FIG. 3 is a flow chart illustrating exemplary operation of the PVR client as it facilitates the viewing of video programs, the storage of the video programs, specification of access rights for sharing and the display of tracking information; and

FIG. 4 is a flow chart illustrating exemplary operation of the PVR client as it facilitates the retrieval of stored video programs for viewing by a user, the stored video programs being retrieved from a PVR server.

### DETAILED DESCRIPTION OF THE PREFERRED EMBODIMENT(S)

The present invention relates generally to storage and retrieval of video content by a user employing a remote storage facilities provided by personal video recording network. Although the following discusses aspects of the invention in terms of a personal video recording network, it should be clear that the following also applies to other systems such as but not limited to, for example, live video broadcast, camcorder content upload systems, internet-based video storage systems, etc.

The personal video recording network can be used in variety of ways, including the recording of movies, home videos, etc. It can also be used for sharing home videos, for example, with extended family members, some of whom are located in remote destinations.

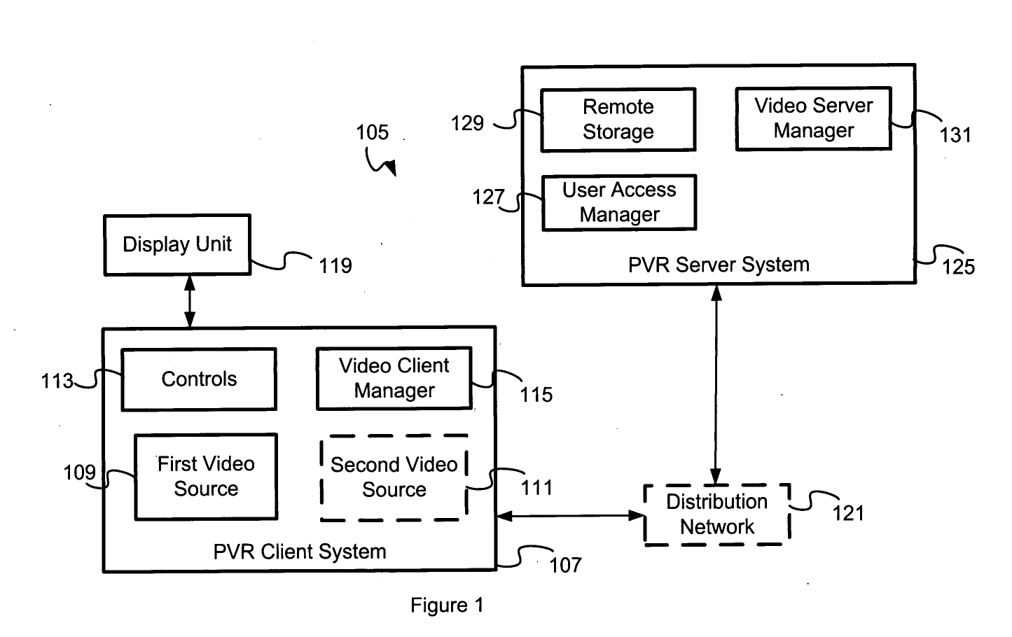

FIG. 1 illustrates a block diagram of an exemplary personal video recorder network in accordance with an embodiment of the present invention. The personal video recording network 105 can include one or more Personal Video Recording (PVR) client system 107, a PVR server system 125 communicatively coupled to the PVR client system over a distribution network 121, a display unit 119 communicatively coupled to the PVR client system and the personal video recorder network 105 providing shared access to a video content stored at the PVR server system 125 such that the PVR client system 107 can retrieve the video content and display it on the display unit 119.

The PVR client system 107 includes a first video source 109 that accesses local video data, an optional second video source 111, a controlling circuit 113 and a video client manager 115 that facilitates storing the local video data at the PVR server system 125, retrieving of the local video data from the PVR server system 125 and displaying of the retrieved local video data on the display unit 119. Video programs or multimedia content received by the PVR client system 107 from the first video source is typically viewed by the user on the display unit 119. If such video programs or multimedia content need to be stored, then the PVR client system 107 stores them at the PVR server system 125. Such stored video programs can be retrieved for viewing, shared with other viewers, or deleted subsequently. When the stored programs are shared with other viewers, the user, with the help of the video client manager 115, can send a reference to the video program or multimedia content to another viewer's PVR client system 107. Sharing is possible, for example, when only if the owner of the shared video program or multimedia content sets appropriate access rights on the shared content.

The PVR server system 125 comprises a remote storage 129 for storing video content provided by the PVR client system 107 and a video server manager 131 that facilitates the storage from, and retrieval by, the PVR client system 107. It also comprises a user access manager 127 that determines if the storage and retrieval from the PVR client system 107 is to be enabled.

Interactions and communications between the PVR server system 125 and the PVR client system 107 are secure, employing security mechanisms as appropriate, and employing secure channels, as needed. In one embodiment, communications between the PVR server system 125 and the PVR client system 107 occurs over a secure socket layer (SSL). In a related embodiment, it occurs over a TLS network. Other secure communication means are also anticipated. In one embodiment, a secure channel is implemented (such as by using hardware encryption and decryption means), wherein video data communicated over the secure channel are processed by digitising (if needed) and encrypting at one end and by decrypting at the other end.

In one embodiment, the user on the PVR client system 107 can set access control rights (ACL) on the shared content in the PVR server system 125 that enables some viewers to access the shared content while prohibiting others from such access.

In general, access to stored content in the PVR server system 125 is controlled by the user access manager 127, which authenticates user access and ensures that users with appropriate access rights are allowed access to shared content and illegal access is prohibited. In one embodiment, such authentication of the user is facilitated by means of a client authentication system that is based on the use of digital certificates. For example, each user is given a client certificate that authorizes the user to access specific content stored in the PVR server system 125. Such a client certificate is installed in the PVR client system 107 and employed during communications with the PVR server system 125.

In one embodiment, the user is given a user account and a password that allows the user access to the PVR server system 125 for storage of content or for retrieval of stored content. The user can then share that password (or create a new one) with others so as to enable access by them to the stored content.

In one embodiment, the PVR server system 125 provides the only storage means for storage and retrieval of video programs and multimedia content that a plurality of PVR client systems 107 employ as a remote storage means. Each of the plurality of PVR client systems 107 has complete read, write and erase access rights to their content stored on the PVR server system 125. However, they must be granted read access to be able to retrieve or view stored video programs or multimedia content that are “owned” by others, or stored by others, in the PVR server system 125.

In one embodiment, the video client manager 115 facilitates setting up a schedule for automatic storage of specific video programs in the PVR server system 125. The PVR client systems 107 receives a notification when a new video program is stored in the PVR server system 125 by another user who has provided access rights to video programs stored by him.

Although the PVR client systems 107 of the personal video recording network 105 has been described to include the first video source 109 and the optional second video source 111, it should be clear that the PVR client systems 107 need not be restricted to only two video sources. Rather, the PVR client systems 107 are, in general, capable of supporting multiple video sources.

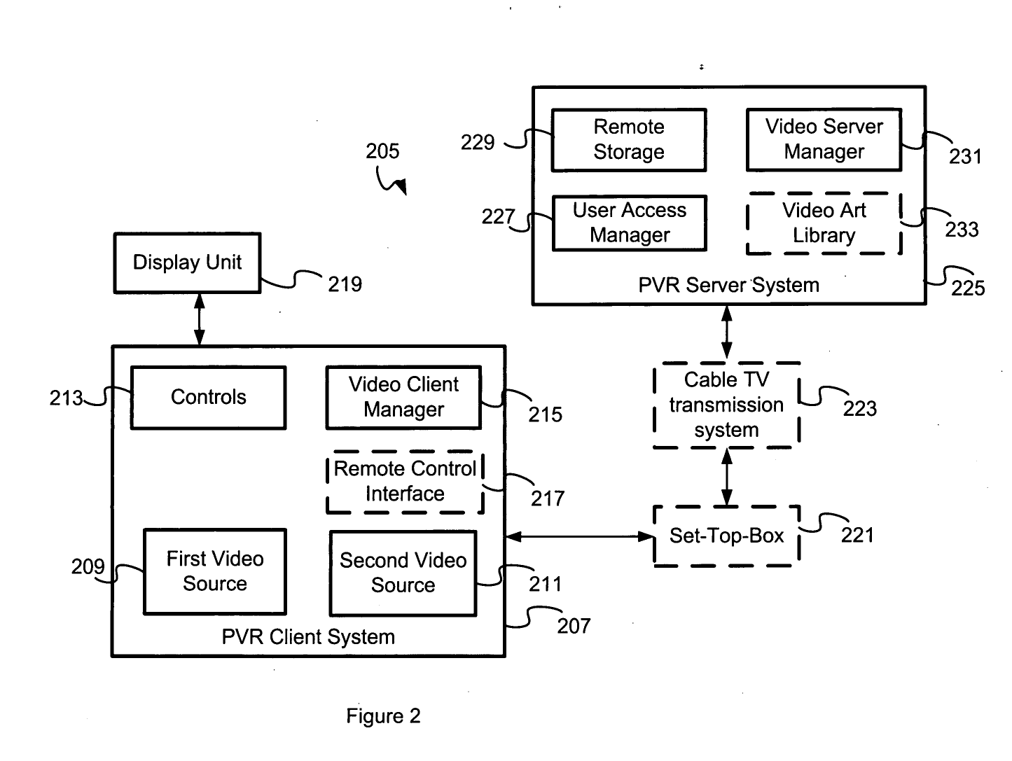

FIG. 2 is a block diagram of a personal video recorder network 205 that comprises a PVR client system 207 communicatively coupled to a PVR server system 225 via a set-top-box 221 and a cable TV transmission system 223. The PVR client system 207 may be incorporated into the set-top-box 221. The PVR server system 225 may be incorporated into a cable TV transmission system 223. The set-top-box 221 is communicatively coupled to the PVR client system 207 and facilitates the reception of cable TV multimedia content. A display unit 219 communicatively coupled to the PVR client system 207 facilitates viewing of video programs and multimedia content. The cable TV transmission system 223 communicatively coupled to the set-top-box 221 enables transmission of cable TV multimedia content. The PVR server system 225 communicatively coupled to the cable TV transmission system 223 employs the cable TV transmission system 223 to communicate with the PVR client system 207.

The PVR client, system 207 includes an option of remote control interface 217 that makes it possible to operate the PVR client system 207 employing a remote control. The PVR server system 225 comprises an optional video art library 233 that makes pre-recorded video files or motion pictures library accessible to the user:

The set-top-box 221 facilitates reception and selection of cable TV programme that is displayed on the display unit 219. The video client manager 215 facilitates the recording at least a portion of a cable TV program at the PVR server system 225. It also facilitates the subsequent retrieval of the at least a portion of a cable TV program recorded from the PVR server system 225, for display on the display unit 219.

At least one channel of a cable TV transmission may be used to communicate (such as streaming communication) stored video programs from the video server manager 231 to the PVR client system 207. In one embodiment, the remote storage 229 and the video server manager 231 are combined into a content server located at the cable TV service provider's location, as part of the PVR server system 225. A service provider's content server transmits stored multimedia programs on one of the channels of the cable TV programming received by the set-top-box 221. Such transmission is done simultaneously to the regular cable TV programming between the cable TV transmission system 223 and the set-top-box 221.

Multiple end-users, or customers, subscribe to the services (channels) provided by the personal video recorder network 205. A television (TV) set acts as the display unit 219 in one embodiment. The set-top-box (STB) 221, typically located at the end-user's premises, is used to decode and display the multimedia content of the cable TV channels subscribed to by a user. The STB 221 provides end-users access to only those cable TV channels that the end-user has subscribed to, the free channels and to additional channels, which corresponds to the TV programs previously recorded, or uploaded by the user at the PVR server system 225.

In one embodiment, one of the cable TV channels is dynamically established by the video client manager 215 for the end-user to record video content from a VCR, DVD player or a camcorder to which the first video source 209 is communicatively coupled. Such video content is routed to the PVR server system 225 that is located at a remote site for storage and for sharing. The user has access to (such as from a subscription) the PVR server system 225 as a part of their cable TV service plan. The same cable TV channel, such as a dedicated cable TV channel is employed in one related embodiment for uploading video programming to the PVR server system 225. In another embodiment, a different cable TV channel is dynamically allocated to establish a an upload channel for the communicating video or multimedia content from the first 209 or second video source 211 to the PVR server system 225. Such uploaded video programs such as home videos, can be stored, retrieved, and secure shared with other viewers.

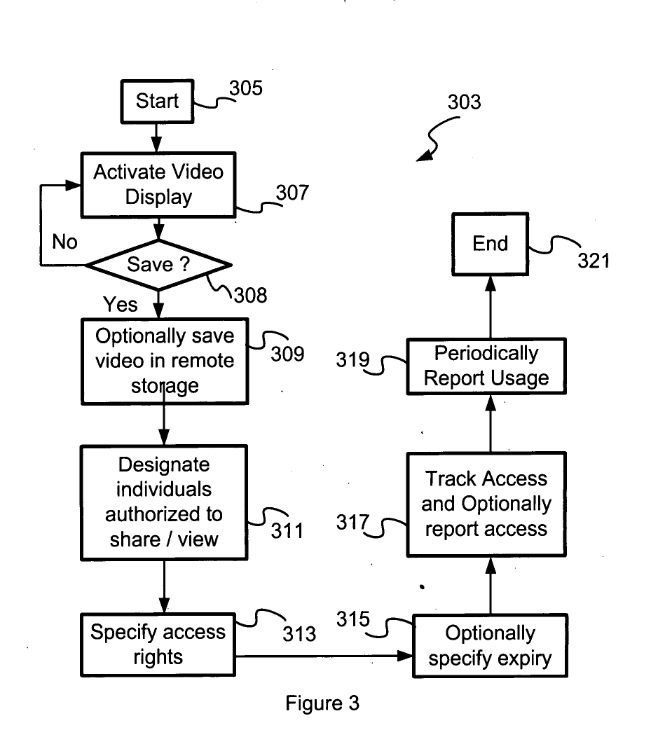

FIG. 3 is a flow chart 303 illustrating exemplary operation of the PVR client as it facilitates the viewing of video programs, the storage of the video programs, specification of access rights for sharing and the display of tracking information. At a start block 305, the PVR client is initialized, such as when the PVR client is turned on to start the display of a video program. Then, at a next block 307, the display of the video is activated per user selections, such selections made through a remote control device compatible with the PVR client.

Then, at a next decision block 308, an attempt is made to determine if the user wants to save the currently viewed video program. If, at the decision block 308,it is determined that the user does not want to save the program, then, at the next block 307, the display of the video is continued per user selection. Otherwise, if the user decides to save the current video program (being currently displayed by the PVR client),then, at a next block 309, video storage is enabled wherein the user is able to optionally save video programs currently being viewed at a remote storage associated with, and communicatively coupled to, the PVR client. Then, at a next block 311, the user is optionally, based on user preferences, prompted to designate individuals authorized to share or view the stored video programs. Then, at a next block 313, the user can specify access rights to others, such as guests who might want to access the stored programs.

Then, at a next block 315, the expiry dates/time for the stored video programs are optionally specified. Subsequently, at a block 317, the PVR client tracks access to the shared video programs such access being allowed based on access rights previously specified by a user, or based on default behaviors. In addition, the PVR client can periodically, or on the occurrence of a remote access by a shared user (another user authorized to access) report the access to shared video programs and video data, such as photographs, home videos, etc.

Then, at a next block 319, the PVR client determines if there is a need to make a periodic report to a user of stored video programs, and, if it is determined to be necessary, the PVR client displays a report to the user. Finally, the PVR client terminates processing at an end block 321.

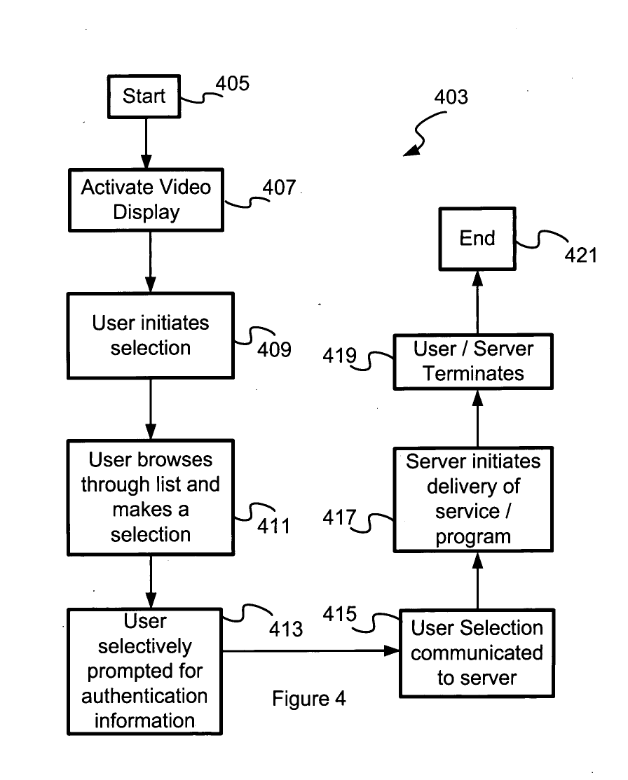

FIG. 4 is a flow chart 403 illustrating exemplary operation of the PVR client as it facilitates the retrieval of stored video programs for viewing by a user, the stored video programs being retrieved from a PVR server. At a start block 405, the PVR client is initialized, such as when the PVR client is turned on to start the display of a video program. Then, at a next block 407, the display of the video is activated, and a default selection of available video programs is displayed to prompt user selection, such selections made through a remote control device compatible with the PVR client. In one embodiment, the user is presented with not only a selection of previously stored video programs currently available from the PVR server, but also a selection of live programs, broadcast channels and video program selections that may be owned and managed by other users, to which the user currently has access rights.

Then, at a next block 409, the user optionally initiates specific detailed selections based on the categories of interest. For example, categories such as home videos, broadcast video programs previously stored, sports programs previously stored, movies, video on demand, etc. are displayed for browsing and selection by the user. In one embodiment, a search screen is provided to aid user selection. Then, at a next block 411, the user makes a selection after browsing. Multiple selections are also supported, with the delivery of the selected items provided in the order selected or in random order, based on user preferences.

Then, at a next block 413, the user is optionally prompted for authentication information, such as passwords or identification information. For example, if the user tries to access a video program managed by another user, then the user is prompted to enter a password so as to authenticate the user and confirm his access rights. In one embodiment, a SIM/Smart card user by the user, that can be plugged into the PVR client, provides the necessary authentication and authorization information.

Then, at a next block 415, the user's selection—single or multiple, is communicated to a PVR server. Then, at a block 417, the PVR client receives delivery of the selected program when the PVR server initiates the delivery of the user selections.

Subsequently, at a next block 419, the PVR client or the user determines that all the selected programs have been viewed and initiates a termination. In one embodiment, the user determines that the video programs need to be terminated and initiates termination. Finally, at the next end block 421, the PVR client terminates processing and user log records are created, as necessary, to record the events.

While the present invention is described primarily in terms of the storage and sharing of video programs, it must be clear that it is applicable to other types of multimedia and data such audio, video, graphics, image, text and data through the remote storage provided by the PVR server.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

We claim:

1. A personal video recorder (PVR) system comprising:
a Personal Video Recorder (PVR) client;
a Personal Video Recorder (PVR) server communicatively coupled to the PVR client system through a communications medium;
a display unit coupled to the PVR client,
wherein the personal video recorder system enables shared access to video content stored at the PVR server such that the PVR client can retrieve the multimedia content and display it on the display unit.

2. The PVR system as recited in claim 1, further comprising:
a multimedia source providing local audio, video, graphics and text data to the PVR client system; and
a multimedia client manager that stores the local audio, video, graphics and text data at the PVR server.

3. The PVR system as recited in claim 2, wherein the multimedia client manager enables retrieval of the local video data from the PVR server, and wherein the multimedia client manager enables display of the retrieved local video data on the display unit.

4. The PVR system recited in claim 1, further comprising:
a remote storage for storing video content provided by the PVR client, wherein the remote storage retrieves the video content from the PVR server and communicates it to the PVR client system.

5. The PVR system recited in claim 4, further comprising:
a video server manager for managing storage from and retrieval by the PVR client system; and
a user access manager that enables storage and retrieval from the PVR client.

6. The PVR system recited in claim 1, further comprising:
a video client manager in the PVR client, enabling storage of a local video data captured by the PVR client in the PVR server; and
the video client manager facilitating the retrieval of the stored local video data by the PVR client from the PVR server and its display on the display unit.

7. A personal video recorder network comprising:
a first local video system comprising a local video display;
a remote storage; and
an user access control mechanism.

8. The personal video recorder network recited in claim 7 wherein the user access control makes it possible for a plurality of users to share with others access to a video data that is captured by the first local video system and stored at the remote storage.

9. The personal video recorder network of claim 7 further comprising:
the first local video system further comprising a video recorder for recording a video content;
the user access control facilitating the storage of the video content recorded by the video recorder at the remote storage; and
the personal video recorder network providing access to the video content stored at the remote storage.

10. The personal video recorder network recited in claim 9 wherein the user access control provides shared access to a plurality of users to the video content stored at the remote storage.

11. The personal video recorder network of claim 10 further comprising:
an access management interface employed by a first user to specify an access rights to the plurality of users; and
the personal video recorder network providing access to the video content based on the access rights specified by the first user.

12. The personal video recorder network of claim 11 further comprising:
accessing and viewing on the local video display, by the user, a second video content that is stored at the remote storage by one of the plurality of users.

13. The personal video recorder network of claim 12 further comprising:
a plurality of local video systems similar to the first local video system;
the plurality of local video systems recording a personal video data locally, storing then at the remote storage and sharing them from the remote storage.

14. The personal video recorder network of claim 13 further comprising:
the first local video system communicating to at least one of the plurality of local video systems a reference to the video content for sharing; and
the plurality of local video systems accessing the video content from the remote storage and displaying them on their associated local video display.

15. A personal video recorder network that requires no local storage facility, the personal video recorder network comprising:
a PVR client system for capturing a local video data;
a PVR server system communicatively coupled to the PVR client system for facilitating the storage and retrieval of the local video data; and
a display unit communicatively coupled to the PVR client system for displaying the local video data.

16. The personal video recorder network further comprising:
a set-top-box communicatively coupled to the PVR client system that enables reception of cable TV multimedia programs; and
the PVR server system communicatively coupled to the set-top-box and employing set-top-box to communicate with the PVR client system.

17. The personal video recorder network recited in claim 16 wherein the PVR client system is incorporated into the set-top-box.

18. The personal video recorder network recited in claim 17 wherein the PVR server system is incorporated into a cable TV transmission system that employs the set-top-box.

19. The personal video recorder network recited in claim 18 further comprising:
the set-top-box displaying cable TV multimedia programs on the display unit;
the set-top-box recording at least a portion of cable TV multimedia program at the PVR server system; and
the set-top-box facilitating the subsequent retrieval of the at least a portion of cable TV multimedia program stored previously in the PVR server system, for display on the display unit.

20. The personal video recorder network recited in claim 16 wherein the PVR client system comprises a remote control interface for manipulation by a wireless remote control or a wired device.

21. The personal video recorder network recited in claim 16 wherein the PVR server system comprises a video art library to facilitate the ready availability of video files.

22. The personal video recorder network as recited in claim 20, wherein said wired device comprises one of a keyboard, mouse, and tablet.
